(19) United States
(12) Patent Application Publication
(10) Pub. No.: US 2025/0137409 A1
(43) Pub. Date: May 1, 2025

(54) GAS TURBINE SYSTEM AND CONTROL METHOD FOR SAME

(71) Applicant: KAWASAKI JUKOGYO KABUSHIKI KAISHA, Kobe-shi (JP)

(72) Inventors: Shinya ISHIHARA, Kobe-shi (JP); Koji Terauchi, Kobe-shi (JP)

(73) Assignee: KAWASAKI JUKOGYO KABUSHIKI KAISHA, Kobe-shi (JP)

(21) Appl. No.: 19/011,000

(22) Filed: Jan. 6, 2025

Related U.S. Application Data
(63) Continuation of application No. PCT/JP2023/022165, filed on Jun. 14, 2023.

(30) Foreign Application Priority Data
Jul. 8, 2022 (JP) 2022-110802

(51) Int. Cl. F02C 9/26; F02C 7/22

(52) U.S. Cl. CPC F02C 9/26; F02C 7/22

(57) ABSTRACT

A gas turbine system includes: a gas turbine engine including a compressor, a combustor, and a turbine; a fuel gas pressure regulator which regulates the pressure of fuel gas being introduced to the combustor; and a controller configured to: directly derive a designated value for the pressure of the fuel gas being introduced from the fuel gas pressure regulator to the combustor, on the basis of the state of the operation environment for the gas turbine engine; and use the derived designated value for the pressure or the derived designated pressure value to control the fuel gas pressure regulator.

### CROSS REFERENCE TO THE RELATED APPLICATION

This application is a continuation application, under 35 U.S.C. § 111 (a) of international patent application No. PCT/JP2023/022165, filed Jun. 14, 2023, which claims priority to a Japanese patent application No. 2022-110802 filed Jul. 8, 2022, the entire disclosures of all of which are herein incorporated by reference as a part of this application.

### BACKGROUND OF THE INVENTION

### Field of the Invention

The present disclosure relates to a gas turbine system and a control method for the same.

### Description of Related Art

Conventionally, in a gas turbine engine, it is typical for fuel gas to be delivered to a combustor at a fuel gas pressure that is kept at a consistent level during the operation of the engine (see, for example, Patent Document 1). The consistent pressure value for the fuel gas delivery is selected on the basis of the maximum load that is possible at the lowest ambient temperature of the site where the gas turbine engine is located.

### Related Document

### Patent Document

[Patent Document 1] JP Laid-open Patent Publication No. 2011-252397

### SUMMARY OF THE INVENTION

In reality, however, maintaining a fuel gas pressure at a consistent level at all times is not a requirement. For example, a gas turbine engine could even operate on fuel gas that is delivered at a lower pressure, under a certain situation such as when the intake air temperature is high. Put differently, unnecessary operation cost from fuel gas compression may be incurred by operating constantly at a high fuel gas pressure.

While it is proposed in Patent Document 1 to provide a varying pressure for fuel gas being delivered, the proposed control requires acquisition or derivation of parameters not directly relevant to fuel gas pressure, such as internal casing pressure that is estimated on the basis of the opening ratio of inlet guide vanes, and thus complicates the algorithm and system for the control.

An object of the present disclosure is to provide a simple control scheme that reduces the operation cost of a gas turbine engine by making proper adjustments to the pressure of fuel gas being delivered.

The present disclosure provides a gas turbine system which includes:
a gas turbine engine including a compressor, a combustor, and a turbine;
a fuel gas pressure regulator which regulates the pressure of fuel gas being introduced to the combustor; and
a controller configured to: directly derive a designated value for the pressure of the fuel gas being introduced from the fuel gas pressure regulator to the combustor, on the basis of the state of the operation environment for the gas turbine engine; and use the derived designated value for the pressure or the derived designated pressure value to control the fuel gas pressure regulator.

The present disclosure also provides a control method for a gas turbine system having a gas turbine engine which includes a compressor, a combustor, and a turbine and a fuel gas pressure regulator which regulates the pressure of fuel gas being introduced to the combustor, with the method including:
directly deriving a designated value for the pressure of the fuel gas being introduced from the fuel gas pressure regulator to the combustor, on the basis of the state of the operation environment for the gas turbine engine; and
using the derived designated value for the pressure or the derived designated pressure value to control the fuel gas pressure regulator.

A gas turbine system and a control method for the same in accordance with the present disclosure provide a simple control scheme that can reduce the operation cost of a gas turbine engine by making proper adjustments to the pressure of fuel gas being delivered.

Any combinations of at least two features disclosed in the claims and/or the specification and/or the drawings should also be construed as encompassed by the present disclosure. Especially, any combinations of two or more of the claims should also be construed as encompassed by the present disclosure.

### BRIEF DESCRIPTION OF THE DRAWINGS

The present disclosure will be more clearly understood from the following description of preferred embodiments made with reference to the accompanying drawings. However, the embodiments and the drawings are given merely for the purpose of illustration and explanation, and should not be used to delimit the scope of the present disclosure, which scope is to be delimited by the appended claims. In the accompanying drawings, alike numerals are assigned to and indicate alike parts throughout the different figures:

FIG. 1 is a block diagram which shows the general configuration of a gas turbine system in accordance with an embodiment of the present disclosure;

FIG. 2 is a chart which schematically shows an example pressure schedule for fuel gas of the gas turbine system of FIG. 1; and

FIG. 3 is a chart which schematically shows an example control method for the gas turbine system of FIG. 1.

### DESCRIPTION OF EMBODIMENTS

What follows is a description of an embodiment in accordance with the present disclosure, which description is made in line with the drawings. It should be understood, however, that the embodiment is only one of the non-limiting embodiments of the present disclosure. In the following discussions, the terms “upstream” and “downstream” refer to “upstream” and “downstream” sides, respectively, in the direction of flow of air A or fuel gas F.

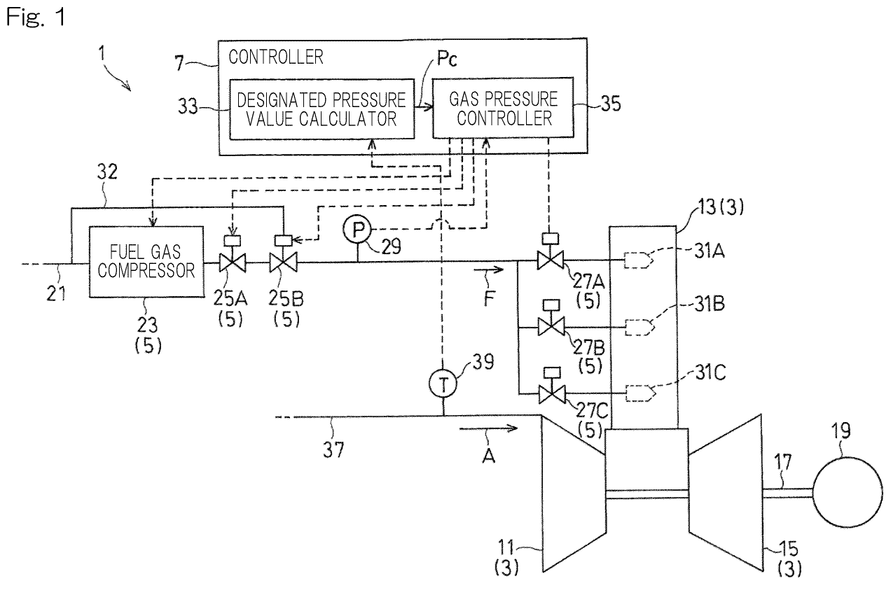

FIG. 1 shows the general configuration of a gas turbine system 1 in accordance with a first embodiment of the present disclosure. The gas turbine system 1 includes a gas turbine engine 3 (which will hereinafter be simply referred to as a “gas turbine”), a fuel gas pressure regulator 5, and a controller 7.

The gas turbine 3 includes a compressor 11, a combustor 13, and a turbine 15 as its principal components. Air A taken into the gas turbine 3 as an operating medium is compressed in the compressor 11 and delivered into the combustor 13 where it is admixed with fuel gas F which is also fed to the combustor 13, resulting in an air-fuel mixture that is burned therein. High-temperature burned gas is generated in the combustor 13 and carried to the turbine 15 to drive the turbine 15 into rotation. The rotary power of the turbine 15 is output via an output rotary shaft 17. The output rotary shaft 17 of the gas turbine 3 couples to a load 19, e.g., a generator, via a speed reducer (not shown).

The fuel gas pressure regulator 5 regulates the pressure of the fuel gas F that is being introduced to the combustor 13. In the instant embodiment, more than one device for regulating the pressure of the fuel gas F is located at a fuel gas introduction passage 21 which introduces the fuel gas F from a fuel gas source into the combustor 13. The more than one device constitutes the “fuel gas pressure regulator 5.” In the illustrated example, the fuel gas pressure regulator 5 includes, in particular, a fuel gas compressor 23 which compresses the fuel gas F from the fuel gas source, a fuel gas pressure regulation valve 25 which regulates the pressure of the fuel gas F which has been compressed by and discharged from the fuel gas compressor 23, a fuel gas control valve 27 which regulates the flow rate of the fuel gas F being introduced into the combustor 13, and a pressure detector 29 located downstream of the fuel gas pressure regulation valve 25.

Specifically, the fuel gas pressure regulation valve 25 in the illustrated example provides a first gas pressure regulation valve 25A which is formed of a slide valve, and a second gas pressure regulation valve 25B which is in the form of a bypass valve arranged downstream of the first gas pressure regulation valve 25A. The second gas pressure regulation valve 25B in the form of a bypass valve connects to a fuel gas bypass path 32 which communicates with the upstream side of the fuel gas compressor 23.

Further, in the illustrated example, the fuel gas control valve 27 provides a first fuel gas control valve 27A, a second fuel gas control valve 27B, and a third fuel gas control valve 27C. These fuel gas control valves 27 are each associated with a respective one of several fuel gas injector nozzles 31 disposed in the combustor 13. For instance, the first fuel gas control valve 27A regulates the flow rate of the fuel gas to be supplied to a pilot fuel injector nozzle 31A, the second fuel gas control valve 27B regulates the flow rate of the fuel gas to be supplied to a main fuel injector nozzle 31B, and the third fuel gas control valve 27C regulates the flow rate of the fuel gas to be supplied to a reheat fuel injector nozzle 31C. Nevertheless, the number and arrangement of the fuel gas control valves 27 may be selected as appropriate according to the specification of the combustor 13, with their number and arrangement in the instant example being only one of non-limiting examples thereof.

While the controller 7 may be responsible for controlling the operation of the gas turbine system 1 in general, only those functions and features of the controller 7 that pertain to control of the pressure of the fuel gas F will be discussed herein.

Control operations by the controller 7 of the gas turbine system 1, that is, a control method for the gas turbine system 1 will be the subject of the discussions that follow.

In the instant embodiment, the controller 7 directly derives or calculates a designated value for the pressure of the fuel gas F being introduced from the fuel gas pressure regulator 5 to the combustor 13, on the basis of the state of the operation environment for the gas turbine 3, and then, uses the derived designated pressure value to control the fuel gas pressure regulator 5. Thus, the pressure of the fuel gas F being introduced from the fuel gas pressure regulator 5 to the combustor 13 can be adjusted by the controller 7 according to the state of the operation environment for the gas turbine 3.

In the illustrated example, the controller 7 includes a designated pressure value calculator 33 and a gas pressure controller 35. The designated pressure value calculator 33 directly derives or calculates the designated pressure value on the basis of the state of the operation environment. The gas pressure controller 35 controls the fuel gas pressure regulator 5. It should be noted that the designated pressure value calculator 33 and the gas pressure controller 35 may not necessarily be provided as distinct pieces of hardware; the designated pressure value calculator 33 and the gas pressure controller 35 in FIG. 1 are only presented for illustration purposes.

The term “state of operation environment” used herein refers to the state of the ambient environment that may affect the operation of the gas turbine 3. Examples of parameters indicative of the state of the operation environment include intake air temperature, fuel density, fuel temperature, and ambient pressure at the site where the gas turbine 3 is located. Put differently, the state of the operation environment does not include the state of the operation of the components of the gas turbine 3 in operation, e.g., the opening ratio of inlet guide vanes, a compressor discharge pressure, etc.

In the instant embodiment, the controller 7 directly derives or calculates from parameter(s) indicative of the state of the operation environment as described above the designated value Pc for the pressure of the fuel gas F to be delivered to the combustor 13 (which may hereinafter be simply referred to as a “designated pressure value.”). The controller 7 in turn uses the designated pressure value Pc to control the fuel gas pressure regulator 5. The phrase “directly derive/deriving or calculate/calculating a designated value Pc for pressure (or a designated pressure value Pc)” used in this context is intended to mean that the designated pressure value Pc is derived or calculated on the basis of parameter(s) indicative of the state of the operation environment without involving parameter(s) pertaining to the internal state of the operation of the gas turbine 3 such as, e.g., a compressor discharge pressure and casing pressure.

For instance, the controller 7 derives or calculates the designated pressure value Pc for the fuel gas F to be delivered to the combustor 13 as a function f of intake air temperature, fuel gas density, and fuel gas temperature according to equation (1) below:

$$P = f ( intake air temperature , fuel gas density , fuel gas temperature ) + fuel control valve pressure loss + piping pressure loss \qquad ( 1 )$$

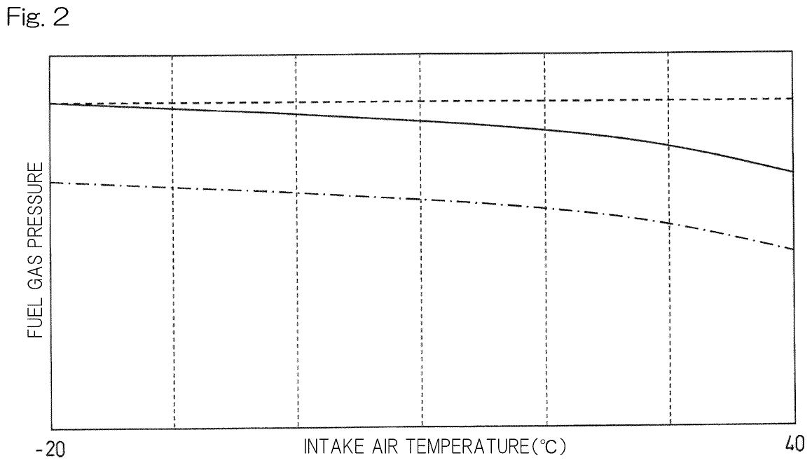

It should be noted that the function f used for designation of the pressure value Pc by the controller 7 does not have to be a function of all of the elements that are listed above as the parameters indicative of the state of the operation environment, such as intake air temperature, fuel gas density, and fuel gas temperature, and/or others. Rather, it may be a function of a subset thereof, e.g., a function of intake air temperature only. FIG. 1 depicts an example in which the controller 7 regulates the fuel gas pressure on the basis of intake air temperature. Thus, in FIG. 1, a temperature detector 39 that senses the intake air temperature is located at an intake air passage 37 which introduces air into the compressor 11. Nevertheless, any detectors necessary for the types of operation environment state parameters for the control can be disposed at locations appropriate therefor. FIG. 2 depicts an example schedule for the designated pressure value Pc where the function f is a function of intake air temperature, in comparison against a conventional schedule where the gas pressure is kept at a consistent level.

In FIG. 2, the conventional schedule for gas pressure is indicated with a broken line, while the schedule for gas pressure where the function f is a function of intake air temperature is indicated with a solid line.

It should be noted that the designated pressure value Pc that is necessary for the operation of the gas turbine 3 may also vary with the load ratio of the gas turbine 3. That is, the gas pressure required during the part load operation of the gas turbine 3 is low relative to the gas pressure required during full load operation of the gas turbine 3. Thus, the controller 7 may determine the designated pressure value Pc by factoring in the load ratio of the gas turbine 3 in addition to the state of the operation environment, as illustrated with a dashed-dotted line in FIG. 2.

In the instant example, control of the fuel gas pressure regulator 5 based on the designated pressure value Pc is executed by changing the rotational speed of the fuel gas compressor 23 and the valve openings of the first gas pressure regulation valve 25A, the second gas pressure regulation valve 25B, and the fuel gas control valves 27A to 27C.

It should be noted that regulation of the pressure of the fuel gas through the control of the fuel gas pressure regulator 5 may involve controlling the rate of pressure change in such a way that prevents an abrupt change in pressure in response to, for example, valve opening adjustment for the first gas pressure regulation valve 25A or the second gas pressure regulation valve 25B.

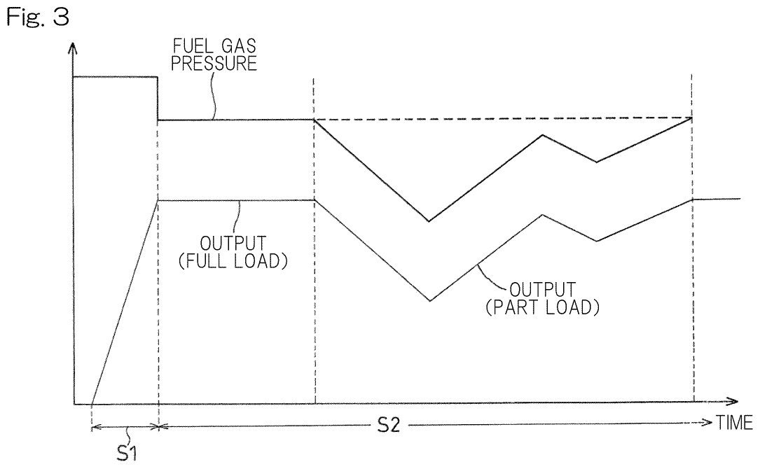

Further, in the instant embodiment, the controller 7 keeps the pressure of the fuel gas at a prescribed consistent value, in a state S1 from the start-up of the gas turbine 3 until a steady operation is reached, and regulates the pressure of the fuel gas according to the state of the operation environment, once the gas turbine 3 has attained a steady operation state S2, as shown in FIG. 3. It should be noted that FIG. 3 illustrates a case in which the steady operation state S2 begins with full load operation and subsequently transitions into part load operation.

Thus, by keeping the pressure of the fuel gas at a prescribed consistent value from the start-up of the gas turbine 3 until a steady operation is reached, the operation of the gas turbine 3 during its start-up where the operation tends to be less stable can be stabilized with the aid of consistency in the fuel gas pressure quantity. In addition, through the adjustments made to the pressure of the fuel gas in a steady operation that follows, the operation cost can be reduced. It should be noted that it is optional for the pressure of the fuel gas F to be kept at a prescribed consistent value from the start-up of the gas turbine 3 until its steady operation is reached. Regulation of the pressure of the fuel gas F according to the state of the operation environment may even begin at the start-up of the gas turbine 3.

It should be noted that the controller 7 illustrated in FIG. 1 can feature, for example, a variety of circuits that perform processing necessary for the abovementioned control, a memory for storing information required in the processing, a power device such as a battery or a power circuit for receiving external power supply, a receiver circuit for cabled or wireless reception of external input signals, and a transmitter circuit for cabled or wireless transmission of output signals to an external entity. Moreover, the controller 7 may feature, among other components, a sensor device which senses a physical quantity of interest (e.g., pressure, temperature, and/or flow rate), a variety of circuits that perform necessary processing of the acquired sensing quantity like signal conversion, computation, or other processing, a memory for storing information required in the processing, a power device such as a battery or a power circuit for receiving external power supply, and a transmitter circuit for cabled or wireless transmission of output signals to an external entity.

It should be noted that example types of the fuel gas F to be used for the operation of the gas turbine 3 can include, but not limited to, commonly available fuel gases like natural gas, utility gas, biogas, liquefied petroleum gas, coke oven gas, VR gasified gas, and hydrogen gas.

Moreover, the fuel gas pressure regulator 5 illustrated in the instant embodiment which includes the fuel gas compressor 23, the fuel gas pressure regulation valve 25, and the fuel gas control valve 27 is only one of the non-limiting particular example configurations of the fuel gas pressure regulator 5. For instance, if the source of the fuel gas F has a pressure control capability, the source itself can be incorporated as one of the components of the fuel gas pressure regulator 5. Furthermore, the gas turbine system 1 may also include a variety of devices and valves necessary for the operation of the present system, in addition to those shown in FIG. 1.

A first aspect of the instant embodiment provides a gas turbine system 1 which includes: a gas turbine engine 3 including a compressor 11, a combustor 13, and a turbine 15; a fuel gas pressure regulator 5 which regulates the pressure of fuel gas F being introduced to the combustor 13; and a controller 7 configured to: directly derive or calculate a designated value for the pressure of the fuel gas F being introduced from the fuel gas pressure regulator 5 to the combustor 13, on the basis of the state of the operation environment for the gas turbine engine 3; and use the derived designated value for the pressure or the derived designated pressure value to control the fuel gas pressure regulator 5.

According to this configuration, the simple control scheme of directly deriving a required gas pressure from the state of the operation environment can be used to make proper adjustments to the pressure of the fuel gas F being delivered. Since unnecessary operation cost of the fuel gas pressure regulator 5 can thus be saved, the operation cost of the gas turbine 3 in general can be reduced.

A second aspect of the instant embodiment provides a feature wherein the controller 7 is configured to directly derive or calculate the designated pressure value on the basis of at least one of the following parameters indicative of the state of the operation environment: intake air temperature; fuel density; or fuel temperature, in the gas turbine system 1 in accordance with the first aspect. According to this configuration, more efficient control of the pressure of the fuel gas F is possible because operation environment state parameter(s) having considerable impact on the required fuel gas pressure is/are relied upon.

A third aspect of the instant embodiment provides a feature wherein the controller 7 is configured to directly derive or calculate the designated pressure value additionally on the basis of the load ratio of the gas turbine engine 3, in the gas turbine system 1 in accordance with the first or second aspect. According to this configuration, the pressure of the fuel gas can be controlled in a more appropriate manner according to the load ratio during part load operation of the gas turbine 3.

A fourth aspect of the instant embodiment provides a feature wherein the controller 7 is configured to: keep the pressure of the fuel gas F at a prescribed consistent value, from the start-up of the gas turbine engine 3 until a steady operation is reached; and then, use the designated pressure value to control the fuel gas pressure regulator 5, once the steady operation of the gas turbine engine 3 is reached, in the gas turbine system 1 in accordance with one of the first to third aspects. According to this configuration, the operation of the gas turbine 3 engine during its start-up where the operation tends to be less stable can be stabilized with the aid of consistency in the fuel gas pressure quantity, while reducing the operation cost through the adjustments made to the pressure of the fuel gas in a steady operation that follows.

A control method for the gas turbine system 1 in accordance with the first aspect of the instant embodiment, where the gas turbine system 1 has a gas turbine engine 3 which includes a compressor 11, a combustor 13, and a turbine 15 and a fuel gas pressure regulator 5 which regulates the pressure of fuel gas F being introduced to the combustor 13, includes:
directly deriving or calculating a designated value for the pressure of the fuel gas F being introduced from the fuel gas pressure regulator 5 to the combustor 13, on the basis of the state of the operation environment for the gas turbine engine 3; and
using the derived designated value for the pressure or the derived designated pressure value to control the fuel gas pressure regulator 5.

According to this configuration, the simple control scheme of directly deriving a required gas pressure from the state of the operation environment can be used to make proper adjustments to the pressure of the fuel gas F being delivered. Since unnecessary operation cost of the fuel gas pressure regulator 5 can thus be saved, the operation cost of the gas turbine 3 in general can be reduced.

A control method in accordance with the second aspect of the instant embodiment provides a feature wherein the directly deriving or calculating comprises directly deriving the designated pressure value, on the basis of at least one of the following parameters indicative of the state of the operation environment: intake air temperature; fuel density; or fuel temperature, in the control method in accordance with the first aspect. According to this configuration, more efficient control of the pressure of the fuel gas F is possible because operation environment state parameter(s) having considerable impact on the required fuel gas pressure is/are relied upon.

A control method in accordance with the third aspect of the instant embodiment provides a feature wherein the directly deriving or calculating comprises deriving the designated pressure value, additionally on the basis of the load ratio of the gas turbine engine 3, in the control method in accordance with the first or second aspect. According to this configuration, the pressure of the fuel gas can be controlled in a more appropriate manner according to the load ratio during part load operation of the gas turbine 3.

A control method in accordance with the fourth aspect of the instant embodiment provides a feature of further including:
keeping the pressure of the fuel gas F at a prescribed consistent value, from the start-up of the gas turbine engine 3 until a steady operation is reached; and
using the designated pressure value to control the fuel gas pressure regulator 5, once the steady operation of the gas turbine engine 3 is reached, in the control method in accordance with one of the first to third aspects. According to this configuration, the operation of the gas turbine 3 during its start-up where the operation tends to be less stable can be stabilized with the aid of consistency in the fuel gas pressure quantity, while reducing the operation cost through the adjustments made to the pressure of the fuel gas in a steady operation that follows.

While preferred embodiments of the present disclosure have been described thus far with reference to the drawings, various additions, modifications, or omissions can be made therein without departing from the principle of the present disclosure and are, thus, encompassed within the scope of the present disclosure.

### Reference Symbols

1 . . . gas turbine system
3 . . . gas turbine engine
5 . . . fuel gas pressure regulator
7 . . . controller
11 . . . compressor
13 . . . combustor
15 . . . turbine
F . . . fuel gas
Pc . . . designated pressure value

What is claimed is:

1. A gas turbine system comprising:
a gas turbine engine including a compressor, a combustor, and a turbine;
a fuel gas pressure regulator which regulates a pressure of fuel gas being introduced to the combustor; and
a controller configured to:
directly derive a designated value for a pressure of the fuel gas being introduced from the fuel gas pressure regulator to the combustor, on the basis of a state of an operation environment for the gas turbine engine; and
use the derived designated value for the pressure, to control the fuel gas pressure regulator.

2. The gas turbine system as claimed in claim 1, wherein the controller is configured to directly derive the designated value for the pressure, on the basis of at least one of the following parameters indicative of the state of the operation environment: intake air temperature; fuel density; or fuel temperature.

3. The gas turbine system as claimed in claim 1, wherein the controller is configured to directly derive the designated value for the pressure, additionally on the basis of a load ratio of the gas turbine engine.

4. The gas turbine system as claimed in claim 1, wherein the controller is configured to:
keep the pressure of the fuel gas at a prescribed consistent value, from a start-up of the gas turbine engine until a steady operation state is reached; and
use the designated value for the pressure, to control the fuel gas pressure regulator, once the steady operation state of the gas turbine engine is reached.

5. A control method for a gas turbine system having a gas turbine engine which includes a compressor, a combustor, and a turbine and a fuel gas pressure regulator which regulates a pressure of fuel gas being introduced to the combustor, the method comprising:
directly deriving a designated value for a pressure of the fuel gas being introduced from the fuel gas pressure regulator to the combustor, on the basis of a state of an operation environment for the gas turbine engine; and
using the derived designated value for the pressure, to control the fuel gas pressure regulator.

6. The control method as claimed in claim 5, wherein the directly deriving comprises directly deriving the designated value for the pressure, on the basis of at least one of the following parameters indicative of the state of the operation environment: intake air temperature; fuel density; or fuel temperature.

7. The control method as claimed in claim 5, wherein the directly deriving comprises deriving the designated value for the pressure, additionally on the basis of a load ratio of the gas turbine engine.

8. The control method as claimed in claim 5, further comprising:
keeping the pressure of the fuel gas at a prescribed consistent value, from a start-up of the gas turbine engine until a steady operation state is reached; and
using the designated value for the pressure, to control the fuel gas pressure regulator, once the steady operation state of the gas turbine engine is reached.
